(19) United States
(12) Patent Application Publication
(10) Pub. No.: US 2025/0382130 A1
(43) Pub. Date: Dec. 18, 2025

(54) STORAGE SYSTEM

(71) Applicant: AutoStore Technology AS, Nedre Vats (NO)

(72) Inventor: Espen Verpe, Haugesund (NO)

(21) Appl. No.: 18/875,008

(22) PCT Filed: Aug. 28, 2023
(86) PCT No.: PCT/EP2023/073530

§ 371 Date: Dec. 13, 2024

(30) Foreign Application Priority Data
Aug. 29, 2022 (NO) 20220926

(51) Int. Cl. B65G 1/04; F25D 21/04; F25D 25/04; H05B 1/02

(52) U.S. Cl. CPC B65G 1/0464; F25D 21/04; F25D 25/04; H05B 1/023; H05B 2214/02

(57) ABSTRACT

The present invention provides a storage system comprising a framework structure (100) having a plurality of storage columns (105) for accommodating a vertical stack of storage containers (106), and a rail system (108) upon which a container handling vehicle (201,301,401) may move in two perpendicular directions above the storage columns, the rail system comprises a first set of parallel rails (110) and a second set of parallel rails (111) forming a rail grid, wherein each of the rails of the first set of rails (110) and the second set of rails (111) comprises rail portions (6,7) having at least one longitudinal aluminium profile (1,2,3) featuring a hollow section (4,5) extending along the whole length of the profile; wherein each of the rails of the first set of rails (110) and the second set of rails (111) has heat providing means passing through the hollow section.

### FIELD OF THE INVENTION

The present invention relates to a cooled container storage system comprising container handling vehicles arranged to move upon a rail grid on top of the storage system.

### BACKGROUND AND PRIOR ART

FIG. 1 discloses a prior art automated storage and retrieval system with a framework structure 100 and FIGS. 2, 3 and 4 disclose three different prior art container handling vehicles 201,301,401 suitable for operating on such a system.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminium profiles.

The framework structure 100 of the automated storage and retrieval system comprises a horizontal grid-based rail system 108 (i.e. a rail grid) arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a,301a,401a and first and second sets of wheels 201b, 201c, 301b, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c,301c,401c is arranged to engage with two adjacent rails of the second set 111 of rails. At least one of the sets of wheels 201b, 201c, 301b,301c,401b,401c can be lifted and lowered, so that the first set of wheels 201b,301b,401b and/or the second set of wheels 201c,301c,401c can be engaged with the respective set of rails 110, 111 at any one time.

Each prior art container handling vehicle 201,301,401 also comprises a lift device 404, see FIG. 4, for vertical transportation of storage containers 106 (i.e. a container lift device), e.g. raising a storage container 106 from, and lowering a storage container 106 into, a storage column 105. The lift device 404 features a lifting frame 404d comprising container connectors 404b and guiding pins 404c adapted to engage a storage container 106. The lifting frame 404d can be lowered from the vehicle 201,301,401 so that the position of the lifting frame 404d with respect to the vehicle 201,301,401 can be adjusted in a third direction Z which is orthogonal the first direction Y and the second direction X. The lifting device of the container handling vehicle 201 is located within the vehicle body 201a in FIG. 2.

To raise or lower the lifting frame 404d (and optionally a connected storage container 106), the lifting frame 404d is suspended from a band drive assembly by lifting bands 404a. In the band drive assembly, the lifting bands are commonly spooled on/off at least one rotating lifting shaft or reel arranged in the container handling vehicle. Various designs of band drive assemblies are described in for instance WO 2015/193278 A1, WO 2017/129384 A1 and WO 2019/206438 A1.

Conventionally, and also for the purpose of this application, Z=1 identifies the uppermost layer available for storage containers below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a,401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The lateral area defined by a storage column is equal to the lateral area defined by a grid cell 122 of the rail system 108. The lateral area of a grid cell includes the area of the access opening 112 and half the width of the rails at the periphery of the access opening.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1 but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119, 120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lift device 10 404, and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105 or relocated to other storage columns 105.

For monitoring and controlling the automated storage and retrieval system, e.g. monitoring and controlling the location of respective storage containers 106 within the framework structure 100, the content of each storage container 106, and the movement of the container handling vehicles 201,301,401 so that a desired storage container 106 can be delivered to the desired location at the desired time without the container handling vehicles 201,301,401 colliding with each other, the automated storage and retrieval system comprises a control system 500 which typically is computerized and which typically comprises a database for keeping track of the storage containers 106.

The prior art storage systems described above may also be used for freezing and/or cooling of stored items. WO 2015/124610 A1 discloses a storage system, see FIG. 5, configured for cooling items stored in the stacked storage containers 106. The storage system may feature insulated lids arranged at the upper end of each storage column 105 to insulate the storage containers from the surroundings above. A potential problem of having the framework structure 100 at a low temperature required for freezing or cooling stored items, is that cooling of the rail system 108 may cause water condensation and even ice formation on the rails 110,111. Water and/or ice on the rails may cause problems, e.g. loss of wheel traction, for the container handling vehicles 201,301,401 operating thereupon.

An object of the present invention is to provide an improved framework structure for a cooled storage system.

### SUMMARY OF THE INVENTION

The present invention is defined in the attached claims and in the following:

In a first aspect, the present invention provides a storage system comprising a framework structure having a plurality of storage columns for accommodating a vertical stack of storage containers, and a rail system upon which a container handling vehicle may move in two perpendicular directions above the storage columns, the rail system comprises a first set of parallel rails and a second set of parallel rails forming a rail grid, wherein
each of the rails of the first set of rails and the second set of rails comprises rail portions having at least one longitudinal aluminium profile featuring a hollow section extending along the whole length of the profile; wherein
each of the rails of the first set of rails and the second set of rails has heat providing means passing through the hollow section.

In an embodiment of the storage system, the heat providing means may be a heating cable and/or a heated air flow.

In other words, each of the rails of the first set of rails and the second set of rails may comprise a heating cable arranged through the hollow section.

In an embodiment of the storage system, the hollow sections in which the heat providing means are passed may be arranged within an upper portion of the first set of rails and the second set of rails.

In an embodiment of the storage system, the rail portions of the rails of the first set of rails may comprise an upper longitudinal aluminium profile featuring the hollow section, the upper longitudinal aluminium profile having at least one track for the container handling vehicle on an upper external surface thereof, and a lower longitudinal aluminium profile for supporting the upper longitudinal aluminium profile.

In an embodiment of the storage system, the longitudinal aluminium profile of the rail portions of the rails of the second set of rails may have at least one track for the container handling vehicle on an external upper surface thereof, and the hollow section is arranged at a level below a level of the hollow section of the upper longitudinal aluminium profile.

In an embodiment of the storage system, the longitudinal aluminium profiles may have open ends, and the rails of the first set of rails and the second set of rails may comprise a plurality of rail portions connected end to end providing a hollow section extending along the whole length of each of the rails.

In an embodiment of the storage system, the heat providing means may be arranged or passed in a grid pattern coinciding with a grid pattern of the rail system.

In an embodiment, the storage system may comprise at least one temperature sensor for measuring the temperature of the first set of rails and the second set of rails, the temperature sensor may be connected to a controller for regulating a heat output of the heat providing means.

In an embodiment of the storage system, the heat providing means may be a heating cable and the storage system may comprise a power source for providing electricity to the heating cables.

In an embodiment, the storage system may comprise a control system for monitoring and controlling the storage system, the control system being in communication with the power source and/or the temperature sensor, such that the output of the heating cables may be regulated based on the temperature of the rails and/or data received by the control system during operation of the container handling vehicles, such as data indicating wheel slip.

In an embodiment of the storage system, the heating cable may be in contact with an upper surface delimiting the hollow section. This feature may improve the heat transfer between the heating cable and the corresponding rail.

In an embodiment of the storage system, the heating means may be a hot air flow and the storage system may comprise a hot air source connected to an open end of each rail.

In an embodiment, the storage system may be a cooled storage system. The cooled storage system may comprise a cooling system for providing cooled air into the storage columns of the framework structure. In a cooled storage system, the external sides of the framework structure may be isolated from the surroundings by a suitable insulating material. The rail system of the cooled storage system according to the invention may be open to the surroundings.

In a second aspect, the present invention provides a method of constructing a storage system according to any embodiment of the first aspect, the method comprising the steps of:
raising a plurality of upright members to obtain a plurality of storage columns for accommodating a vertical stack of storage containers;
laying a rail system on top of, and supported by, the upright members; and
arranging a heating cable in the hollow section of each of the rails of the first set of parallel rails and the second set of parallel rails.

In an embodiment, the method may comprise the steps of:
connecting the heating cable to a power source and a controller of a temperature sensor.

In an embodiment, the method may comprise the steps of:
installing a control system for monitoring and controlling the storage system, the control system being in communication with the power source and/or the controller of the temperature sensor, such that the output of the heating cables may be regulated based on the temperature of the rails and/or data received by the control system during operation of the container handling vehicles, such as data indicating wheel slip.

### BRIEF DESCRIPTION OF THE DRAWINGS

Embodiments of the present invention are described in detail by way of example only and with reference to the following drawings:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3 is a perspective view of a prior art container handling vehicle having a cantilever for carrying storage containers underneath.

FIG. 4 is a perspective view, seen from below, of a prior art container handling vehicle having an internally arranged cavity for carrying storage containers therein.

FIG. 5 is a side view of a cooled prior art storage system.

FIG. 6 is a top view of a rail system for a storage system according to the invention.

FIGS. 7 and 8 are detailed views of the rail system in FIG. 6.

FIGS. 9 and 10 are sectional views of the rails forming the rail system in FIG. 6.

FIG. 11 is a perspective exploded view of a rail crossing of the rail system in FIG. 6.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

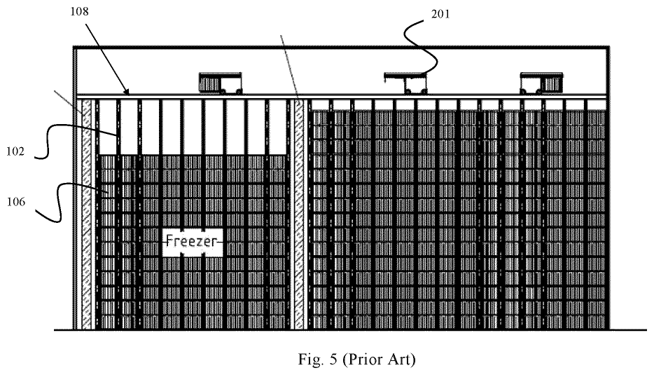

A potential problem in cooled storage systems as described above in connection with FIG. 5 is the formation of ice and/or condensation of water vapor on the rail grid 108 upon which the container handling vehicles 201,301,401 may travel.

The present invention provides a cooled storage system in which the formation of ice and/or condensation of water vapor on the rail grid is minimized or avoided.

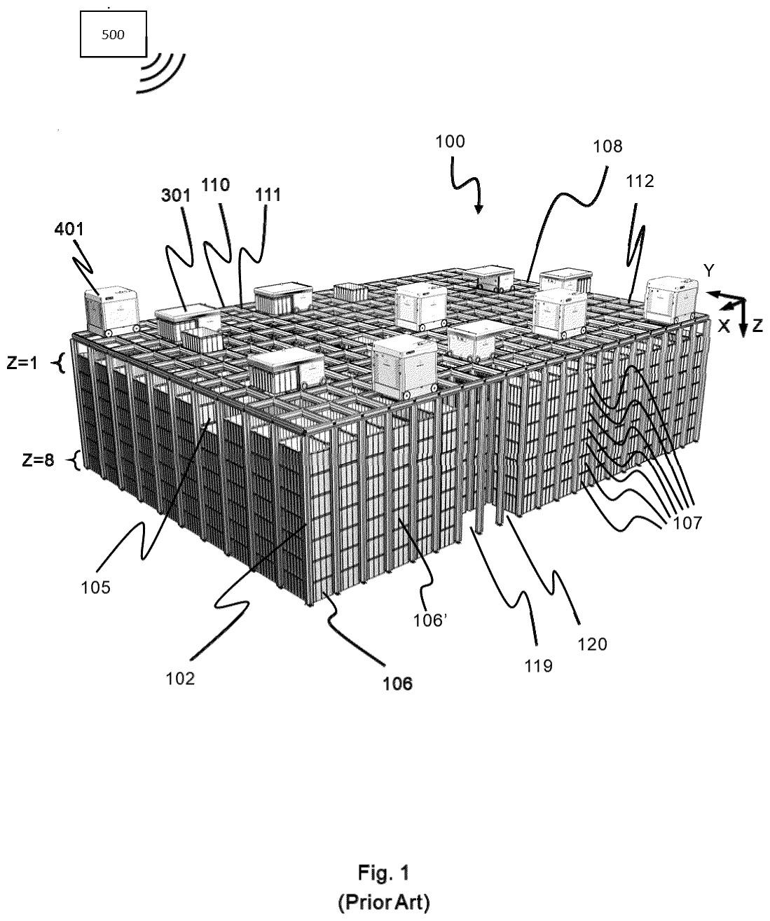

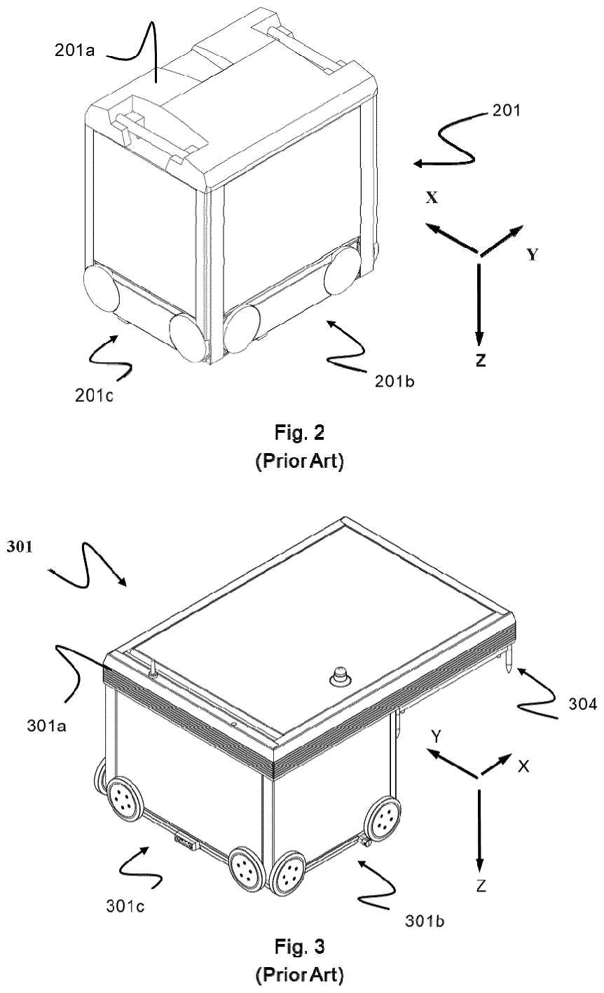

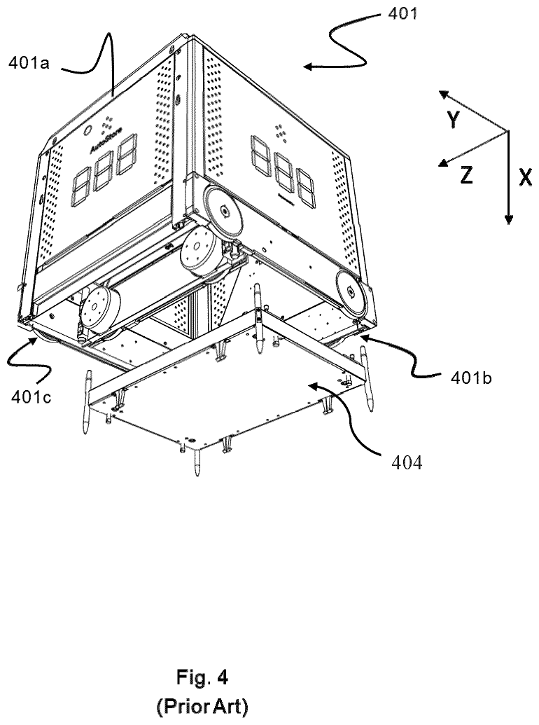

The cooled container handling system, also termed a cooled automated storage and retrieval systems, according to the invention features a framework structure 100 as described above in connection with FIGS. 1 and 5.

The framework structure 100 comprises a plurality of upright members 102 (i.e. vertical column profiles) and a rail system 108 forming a rail grid extending in the first direction X and the second direction Y. The rail system 108 features a first set of parallel rails 110 in the first direction and a second set of parallel rails 111 in the second direction. The upright members 102 define storage columns 105 in which storage containers 106 may be stacked on top of each other.

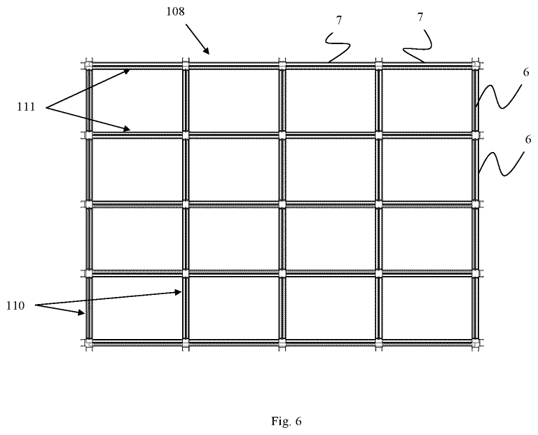

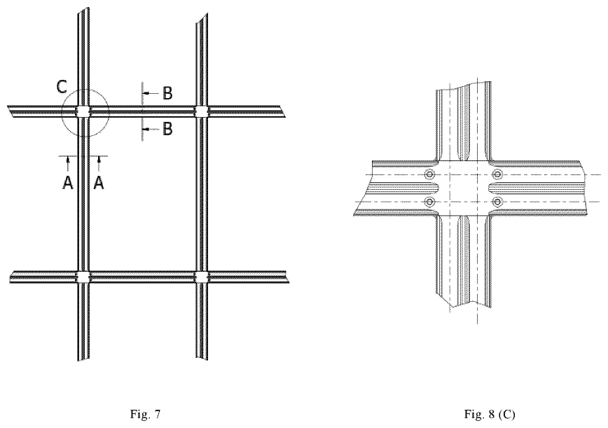

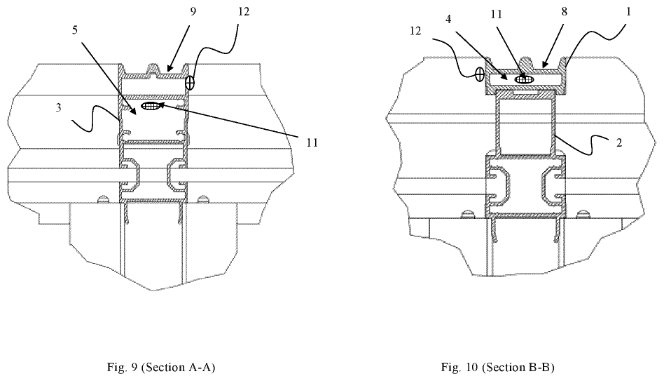

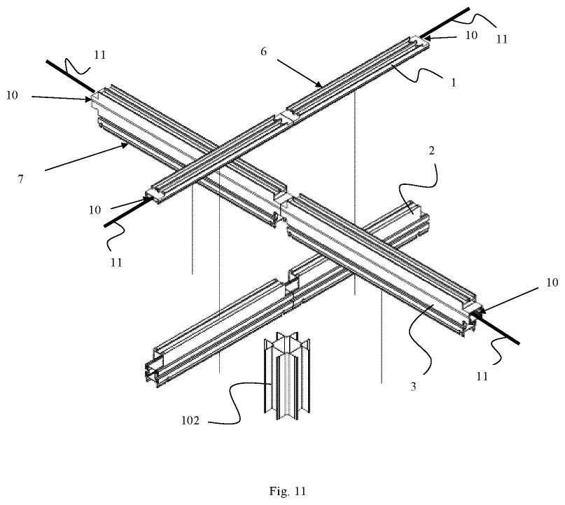

A rail system 108 suitable for the storage system according to the invention is illustrated in FIGS. 6-11.

The rail system comprises a first set of parallel rails 110 and a second set of parallel rails 111 forming a rail grid.

The first set of rails 110 is made up of rail portions 6 having an upper longitudinal aluminium profile 1 featuring a hollow section 4 extending along the whole length of the profile and a lower longitudinal aluminium profile 2 for supporting the upper longitudinal aluminium profile 1. The upper longitudinal aluminium profile 1 has at least one track 8 for a container handling vehicle on an upper external surface thereof. A heating cable 11 is arranged within the hollow section 4.

The second set of rails 111 is made up of rail portions 7 having a single longitudinal aluminium profile 3 featuring a hollow section 5 extending along the whole length of the profile. The single longitudinal aluminium profile 3 has least one track 9 for a container handling vehicle on an external upper surface thereof. The hollow section 5 is arranged at a level below a level of the hollow section 4 of the upper longitudinal aluminium profile 1. A heating cable 11 is arranged within the hollow section 5.

The heating cables may optionally be in contact with an upper surface 13 delimiting the hollow section 4,5. The contact may in some cases improve the heat transfer between the heating cable and an upper portion of the corresponding rail.

The heating cables of the rail system may be connected to a power source of the storage system.

The longitudinal aluminium profiles 1,2,3 have open ends 10 displaying the hollow sections, such that a plurality of rail portions 6,7 connected end to end will provide a hollow section 4,5 extending along the whole length of each of the rails 110,111.

To provide a comprehensive coverage of the rail system, the heating cables 11 may be arranged in a grid pattern coinciding with the grid pattern of the rail system 108.

The heating cables may be self-regulated. Alternatively, the rail system 108 or the storage system may feature at least one temperature sensor 12 for measuring the temperature of the first set of rails 110 and the second set of rails 111. The temperature sensor 12 may be connected to a controller for regulating a heat output of the heating cables.

The storage system according to the invention features a control system 500 for monitoring and controlling the storage system. The control system may advantageously be in communication with the power source and/or the temperature sensor 12, such that the output of the heating cables may be regulated based on the temperature of the rails 110,111. The output of the heating cables may also be regulated based on other data received by the control system during operation, such as data indicating wheel slip of the container handling vehicles.

In an alternative embodiment, the heating cables 11 may be replaced by a flow of hot air. The hot air may be provided by hot air source connected to an open end of each rail.

In the illustrated embodiment, the rails in both the first direction X and the second direction Y have double tracks 8,9, i.e. two parallel tracks adapted for receiving and guiding wheels of a container handling vehicle. However, in alternative embodiments of the invention, one or both set of rails may have a single track.

### LIST OF REFERENCE NUMBERS

1 Upper longitudinal aluminium profile
2 Lower longitudinal aluminium profile
3 Longitudinal aluminium profile
4 Hollow section
5 Hollow section
6 Rail portion of the first set of rails
7 Rail portion of the second set of rails
8 Track
9 Track
10 End of a rail portion
11 Heating cable
12 Temperature sensor
100 Framework structure
102 Upright members of framework structure
104 Storage grid
105 Storage column
106 Storage container
106′ Particular position of storage container
107 Stack
108 Rail system
110 Parallel rails in first direction (X)
112 Access opening
119 First port column
120 Second port column
201 Prior art container handling vehicle
201a Vehicle body of the container handling vehicle 201
201b Drive means/wheel arrangement/first set of wheels in first direction (X)
201c Drive means/wheel arrangement/second set of wheels in second direction (Y)
301 Prior art cantilever container handling vehicle
301a Vehicle body of the container handling vehicle 301
301b Drive means/first set of wheels in first direction (X)
301c Drive means/second set of wheels in second direction (Y)
304 Gripping device 304
401 Prior art container handling vehicle
401a Vehicle body of the container handling vehicle 401
401b Drive means/first set of wheels in first direction (X)
401c Drive means/second set of wheels in second direction (Y)
404 Gripping device
404a Lifting band
404b Gripper
404c Guide pin
404d Lifting frame
500 Control system
X First direction
Y Second direction
Z Third direction

1.-15. (canceled)

16. A storage system comprising:
a framework structure having a plurality of storage columns for accommodating a vertical stack of storage containers; and
a rail system upon which a container handling vehicle may move in two perpendicular directions above the plurality of storage columns, wherein the rail system comprises a first set of rails and a second set of rails configured to form a rail grid, wherein the first set of rails and the second set of rails each comprise rail portions having at least one longitudinal aluminium profile featuring a hollow section extending along a length of the at least one longitudinal aluminium profile, wherein each rail of the first set of rails and the second set of rails has heat providing means passing through the hollow section.

17. The storage system of claim 16, wherein the heat providing means is a heating cable.

18. The storage system of claim 16, wherein the heat providing means is a heated air flow.

19. The storage system of claim 18, further comprising a hot air source connected to an open end of each rail.

20. The storage system of claim 16, wherein the hollow section in which the heat providing means are passed is arranged within an upper portion of both the first set of rails and the second set of rails.

21. The storage system of claim 16, wherein the rail portions of the first set of rails comprise an upper longitudinal aluminium profile featuring the hollow section, the upper longitudinal aluminium profile having at least one track for the container handling vehicle on an upper external surface thereof, and a lower longitudinal aluminium profile for supporting the upper longitudinal aluminium profile.

22. The storage system of claim 21, wherein the at least one longitudinal aluminium profile of the rail portions of the second set of rails has least one track for the container handling vehicle on an external upper surface thereof, and a corresponding hollow section is arranged at a level below a level of the hollow section of the upper longitudinal aluminium profile.

23. The storage system of claim 16, wherein the at least one longitudinal aluminium profile has open ends, and rails of the first set of rails and the second set of rails comprise a plurality of rail portions connected end to end providing the hollow section extending along the length of each of the rails.

24. The storage system of claim 16, wherein the heat providing means are arranged in a grid pattern coinciding with a grid pattern of the rail system.

25. The storage system of claim 16, further comprising at least one temperature sensor for measuring a temperature of the first set of rails and the second set of rails, the at least one temperature sensor connected to a controller for regulating a heat output of the heat providing means.

26. The storage system of claim 16, wherein the heat providing means are heating cables and the storage system comprises a power source for providing electricity to the heating cables.

27. The storage system of claim 25, further comprising a control system for monitoring and controlling the storage system, the control system being in communication with the at least one temperature sensor, such that an output of the heat providing means may be regulated based on a temperature of the first set of rails and the second set of rails.

28. The storage system of claim 26, further comprising a control system for monitoring and controlling the storage system, the control system being in communication with the power source, such that an output of the heating cables may be regulated based on data received by the control system during operation of the container handling vehicle, wherein the data indicates wheel slip.

29. The storage system of claim 16 wherein the heat providing means are heating cables, and the heating cables are in contact with an upper surface delimiting the hollow section.

30. The storage system of claim 16, wherein rails of the first set of rails are parallel and rails of the second set of rails are parallel.

31. A method of constructing the storage system of claim 16, the method comprising:
raising a plurality of upright members to obtain the plurality of storage columns for accommodating the vertical stack of storage containers;
laying the rail system on top of, and supported by, the plurality of upright members; and
arranging a heating cable in the hollow section of each rail of the first set of rails and the second set of rails.

32. The method of claim 31, further comprising connecting the heating cable to a power source and a controller of a temperature sensor.

33. The method of claim 32, further comprising installing a control system for monitoring and controlling the storage system, the control system being in communication with the power source, such that an output of the heating cable may be regulated based on data received by the control system during operation of the container handling vehicle, wherein the data indicates wheel slip.

34. The method of claim 32, further comprising installing a control system for monitoring and controlling the storage system, the control system being in communication with the controller of the temperature sensor, such that an output of the heating cable may be regulated based on a temperature of the first set of rails and the second set of rails.

35. The method of claim 31, wherein the heating cable is arranged in a grid pattern coinciding with a grid pattern of the rail system.
